(19) United States
(12) Patent Application Publication
(10) Pub. No.: US 2010/0035650 A1
(43) Pub. Date: Feb. 11, 2010

(54) Cell phone having air card and/or wifi card

(76) Inventors: Jonathan M. Gottehrer, Massapequa, NY (US); Jerome A. Gottehrer, Massapequa, NY (US)

Correspondence Address: RICHARD L. MILLER, 12 PARKSIDE DRIVE, DIX HILLS, NY, 11746, US

(21) Appl. No.: 12/228,304

(22) Filed: Aug. 11, 2008

(51) Int. Cl. H04M 1/00

(52) U.S. Cl. 455/558

(57) ABSTRACT

A combination Air card, Wi-Fi card, and cellular telephone. The combination includes a housing, an Air card, a Wi-Fi card, a cellular telephone, and apparatus. The Air card and the Wi-Fi card are contained in the housing. The cellular telephone is contained in and on, and operates from, the housing. The apparatus interfaces the Air card and the Wi-Fi card with a computer. In a first embodiment, the apparatus includes pins/sockets on a lower end of the housing, which interface with a card slot in a computer. In a second embodiment, the apparatus includes a USB connector pivotally hinged to a lower end of the housing, which interfaces with a USB port in the computer. In a third embodiment, the apparatus includes a USB connector extending on a cord reelingly captured in a reel on a backside of the housing, which interfaces with the USB port in the computer.

### 1. BACKGROUND OF THE INVENTION

A. Field of the Invention

The embodiments of the present invention relate to a Wi-Fi card, and more particularly, the embodiments of the present invention relate to a combination Air card, Wi-Fi card, and cellular telephone.

B. Description of the Prior Art

Numerous innovations for multi-function cell phones have been provided in the prior art that will be described below in chronological order to show advancement in the art, and which is incorporated herein by reference thereto. Even though these innovations may be suitable for the specific individual purposes to which they address, however, they differ from the present invention in that they do not teach a combination Air card, Wi-Fi card, and cellular telephone.

(1) U.S. Pat. No. 5,020,090 to Morris.

U.S. Pat. No. 5,020,090 issued to Morris on May 28, 1991 in class 379 and subclass 58 teaches apparatus for removably connecting a cellular portable telephone to a laptop or portable computer, which includes a track formed in the housing of the computer and structured to slidably receive a cellular portable telephone whose battery pack has been removed. The track includes a base portion of predetermined width and length, a first edge portion extending outwardly from the base portion, and a second edge portion extending outwardly from the base portion, with the second edge portion being positioned opposite the first edge portion. A first electrical connector is positioned at one end of the track, with a second electrical connector being positioned at the opposite end of the track. Data interface circuitry is connected between the first electrical connector and the modem in the computer. The track is configured to slidably receive a cellular portable telephone available commerically from Motorola, Inc. In order to accommodate cellular portable telephones available commerically from NEC and OKI, a mounting bracket is structured to slidably connect the cellular portable telephones with the track.

(2) U.S. Pat. No. 5,337,346 to Uchikura.

U.S. Pat. No. 5,337,346 issued to Uchikura on Aug. 9, 1994 in class 379 and subclass 58 teaches a portable telephone apparatus equipped with an electronic notebook function. A telephone operation key, such as a dialing key, is mounted on an upper surface of an openable/closable member mounted on an upper surface of a case body. Electronic notebook operation keys, such as a character input key, are provided at a region of a surface of the case body covered by the openable/closable member and also at a rear surface of the openable/closable member. The portable telephone apparatus further includes a switch for detecting an opening/closing state of the openable/closable member, and a mode selecting unit for selecting a telephone mode and an electronic notebook mode in response to a detection signal derived from the detecting signal. Furthermore, a search key for searching storage data about the electronic notebook is employed on this upper surface of the openable/closable member. When this search key is operated, electronic notebook data, such as telephone directory data, constructed of one pair of a telephone number and a name may be displayed on a display unit.

(3) U.S. Pat. No. 5,440,449 to Scheer.

U.S. Pat. No. 5,440,449 issued to Scheer on Aug. 8, 1995 in class 361 and subclass 686 teaches a notebook personal computer in which an I/O connector and module are located at the top of the display screen. The module is L-shaped to conform to the shape of the display screen housing, with the connector to the internal printed circuit input/output card extending into the notebook personal computer frame. The connector is constructed so as to mate with input/output cards that are fitted with a standard input/output card contact design.

(4) U.S. Pat. No. 5,566,226 to Mizoguchi et al.

U.S. Pat. No. 5,566,226 issued to Mizoguchi et al. on Oct. 15, 1996 in class 379 and subclass 58 teaches a data processing apparatus including a card-connecting portion for connecting a card-shaped device therewith, a portable telephone apparatus having a card-shaped portion that can be connected to the card-connecting portion instead of the card-shaped device. The data processing apparatus is for processing a datum. When the card-shaped portion is connected to the card-connecting portion, the datum can be transferred between the data processing apparatus and the card-shaped portion. Therefore, the portable telephone apparatus enables the data processing apparatus to carry out communication relating to the datum.

(5) U.S. Pat. No. 5,657,371 to Suomi et al.

U.S. Pat. No. 5,657,371 issued to Suomi et al. on Aug. 12, 1997 in class 455 and subclass 418 teaches a radio telephone and a computer. The functions are divided substantially into two parts. Adaptation of the levels of the interface connection wires is handled by the circuits of the cradle of the radio telephone, and the control logic is disposed in the communications software of the computer. Physically, the interface includes an RS232 interface for the control and a two-wire PSTN line between the modem and the telephone.

(6) U.S. Pat. No. 6,240,302 to Harrison.

U.S. Pat. No. 6,240,302 issued to Harrison on May 29, 2001 in class 455 and subclass 556 teaches a communications system including a wireless telephone having a PC card rotatably and electrically coupled therewith. The PC card has a Type Two form factor. The system further includes a discrete, independently operably PIM. The PIM includes a housing having a display screen mounted thereon and encloses electronic circuitry. The housing bounds a card slot. The card slot is configured to removably receive the PC card so that the wireless telephone is electrically coupled with the PIM when the PC card is received within the card slot.

(7) U.S. Pat. No. 7,047,038 to Macor.

U.S. Pat. No. 7,047,038 issued to Macor on May 16, 2006 in class 455 and subclass 556.1 teaches a computer and mobile communication system for performing wireless telephone, personal organizer, and/or schedule-alert functions, and a method for operating the system. The system may have a wireless handset for recording and playing messages and for performing scheduling functions. The computer may be located in a base station with a common housing containing a cradle to provide a conduit for exchange of information between the computer and the handset as well as the circuitry to charge a battery in the handset. The handset may be switched between a telephone mode and a personal organizer mode by opening and closing a protective cover.

It is apparent that numerous innovations for multi-function cell phones have been provided in the prior art that are adapted to be used. Furthermore, even though these innovations may be suitable for the specific individual purposes to which they address, however, they would not be suitable for the purposes of the embodiments of the present invention as heretofore described, namely, a combination Air card, Wi-Fi card, and cellular telephone.

### 2. SUMMARY OF THE INVENTION

Thus, an object of the embodiments of the present invention is to provide a combination Air card, Wi-Fi card, and cellular telephone, which avoids the disadvantages of the prior art.

Briefly stated, another object of the embodiments of the present invention is to provide a combination Air card, Wi-Fi card, and cellular telephone. The combination includes a housing, an Air card, a Wi-Fi card, a cellular telephone, and apparatus. The Air card and the Wi-Fi card are contained in the housing. The cellular telephone is contained in and on, and operates from, the housing. The apparatus interfaces the Air card and the Wi-Fi card with a computer. In a first embodiment, the apparatus includes pins/sockets on a lower end of the housing, which interface with a card slot in a computer. In a second embodiment, the apparatus includes a USB connector pivotally hinged to a lower end of the housing, which interfaces with a USB port in the computer. In a third embodiment, the apparatus includes a USB connector extending on a cord reelingly captured in a reel on a backside of the housing, which interfaces with the USB port in the computer.

It is to be noted that a prior art cell phone is not and does not have an air card in it. Both cards are strictly for connecting with a computer or other devices with similar input ports.

The novel features considered characteristic of the embodiments of the present invention are set forth in the appended claims. The embodiments of the present invention themselves, however, both as to their construction and their method of operation together with additional objects and advantages thereof will be best understood from the following description of the specific embodiments when read and understood in connection with the accompanying drawing.

### 3. BRIEF DESCRIPTION OF THE DRAWING

The figures of the drawing are briefly described as follows:

FIG. 1 is an exploded diagrammatic perspective view of a first embodiment of the combination Air card, Wi-Fi card, and cellular telephone of the present invention being inserted into a card slot of a computer and connecting the computer to a cell tower and to a router;

FIG. 2 is an enlarged diagrammatic perspective view of the area generally enclosed by the dotted curve identified by ARROW 2 in FIG. 1 of the combination Air card, Wi-Fi card, and cellular telephone of the first embodiment of the present invention;

FIG. 3 is an exploded diagrammatic perspective view of a second embodiment of the combination Air card, Wi-Fi card, and cellular telephone of the present invention being inserted into a USB port of a computer;

FIG. 4 is an enlarged diagrammatic perspective view of the area generally enclosed by the dotted curve identified by ARROW 4 in FIG. 3 of the combination Air card, Wi-Fi card, and cellular telephone of the second embodiment of the present invention; and

FIG. 5 is a diagrammatic perspective view of the combination Air card, Wi-Fi card, and cellular telephone of a third embodiment of the present invention.

### 4. LIST OF REFERENCE NUMERALS UTILIZED IN THE DRAWING

### A. General

10 combination Air card, Wi-Fi card, and cellular telephone of embodiments of present invention

### B. Overall Configuration of Combination Air Card, Wi-Fi Card, and Cellular Telephone 10

12 housing
14 Air card
16 Wi-Fi card
18 cellular telephone
20 apparatus for interfacing Air card 14 and Wi-Fi card 16 with computer 22
22 computer

### C. First Embodiment of Apparatus 20

24 lower end of housing 12
26 pins/sockets for extending into card slot 28 in computer 22, thereby interfacing Air card 14 and Wi-Fi card 16 with computer 22
28 card slot in computer 22

### D. Second Embodiment of Apparatus 30

31 backside of housing 22
32 USB connector for extending into USB port 34 in computer 22, thereby interfacing Air card 14 and Wi-Fi card 16 with computer 22
34 USB port in computer 22

### E. Third Embodiment of Apparatus 40

42 cord
44 reel

### 5. DETAILED DESCRIPTION OF THE PREFERRED EMBODIMENTS

### A. General

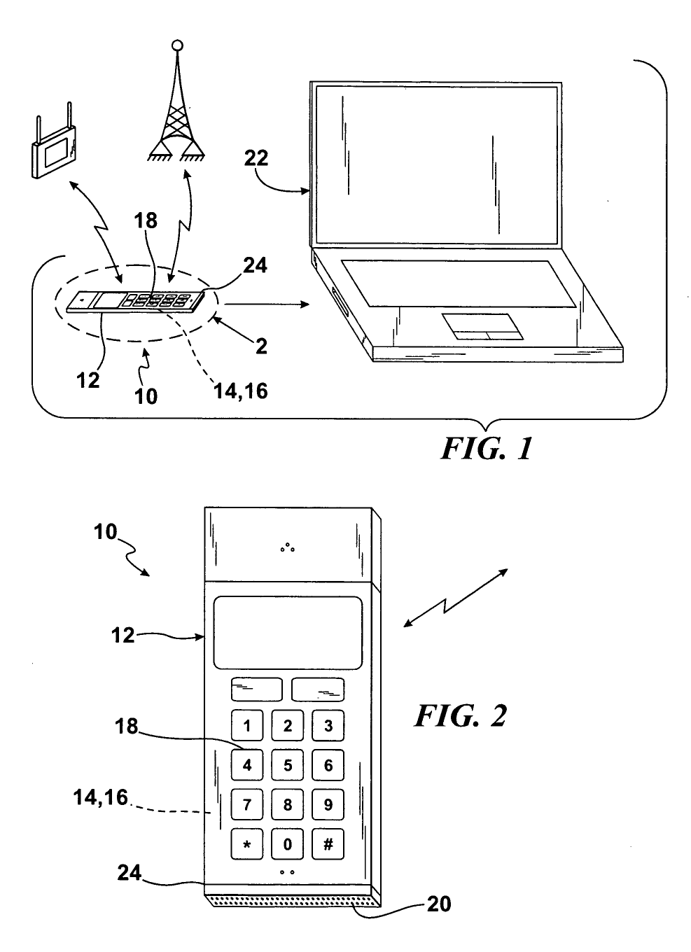

Referring now to the figures, in which like numerals indicate like parts, and particularly to FIG. 1, which is an exploded diagrammatic perspective view of a first embodiment of the combination Air card, Wi-Fi card, and cellular telephone of the present invention being inserted into a card slot of a computer and connecting the computer to a cell tower and to a router, the combination Air card, Wi-Fi card, and cellular telephone of a first embodiment of the present invention is shown generally at 10.

### B. The Overall Configuration of the Combination Air Card, Wi-Fi Card, and Cellular Telephone 10

The overall configuration of the combination Air card, Wi-Fi card, and cellular telephone 10 can best be seen in FIGS. 1 and 2, which are, respectively, again an exploded diagrammatic perspective view of a first embodiment of the combination Air card, Wi-Fi card, and cellular telephone of the present invention being inserted into a card slot of a computer and connecting the computer to a cell tower and to a router, and an enlarged diagrammatic perspective view of the area generally enclosed by the dotted curve identified by ARROW 2 in FIG. 1 of the combination Air card, Wi-Fi card, and cellular telephone of the first embodiment of the present invention.

The combination Air card, Wi-Fi card, and cellular telephone 10 comprises a housing 12, an Air card 14, a Wi-Fi card 16, a cellular telephone 18, and an apparatus 20. The Air card 14 and the Wi-Fi card 16 are contained in the housing 12. The cellular telephone 18 is contained in and on, and operates from, the housing 12. The apparatus 20 is accessible from the housing 12 and is for interfacing the Air card 14 and the Wi-Fi card 16 with a computer 22.

### C. The Air Card 14

(1) An Air Card is a Wireless Modem.

Mobile phones can be employed as data modems to form a wireless access point connecting a personal computer to The Internet or some proprietary network. In this use, the mobile phone is providing a gateway between the cellular service provider's data network technology and Point-to-Point Protocol (PPP) spoken by PCs. Almost all current mobile phone models support the Hayes command set, a standard method of controlling modems. To the PC, the phone appears like an external modem when connected via serial cable, USB, IrDA infrared, or Bluetooth wireless.

Wireless data modems are also used in the Wi-Fi and WiMAX standards operating at microwave frequencies to give a laptop, PDA, or desktop computer an access point to a network. If combined with VoIP technology, these computing devices can achieve telephony capability to make and receive telephone calls.

(2) History.

While some analogue mobile phones provided a standard RJ11 telephone socket into which a normal landline modem could be plugged, this only provided slow dial-up connections, usually 2.4 kilobit per second (kbit/s) or less. The next generation of phones, known as 2G (for ‘second generation’), were digital, and offered faster dial-up speeds of 9.6 kbit/s or 14.4 kbit/s without the need for a separate modem. A further evolution called HSCSD used multiple GSM channels (two or three in each direction) to support up to 43.2 kbit/s. All of these technologies still required their users to have a dial-up ISP to connect to and provide the Internet access -it was not provided by the mobile phone network itself.

The release of 2.5G phones with support for packet data changed this. The 2.5G networks break both digital voice and data into small chunks, and mix both onto the network simultaneously in a process called packet switching. This allows the phone to have a voice connection and a data connection at the same time, rather than a single channel having to be used for one or the other. The network can link the data connection into a company network, but for most users the connection is to the Internet. This allows web browsing on the phone, but a PC can also tap in to this service if it connects to the phone. The PC needs to send a special telephone number to the phone to get access to the packet data connection. From the PC's viewpoint, the connection still looks like a normal PPP dial-up link, but it is all terminating on the phone, which then handles the exchange of data with the network. Speeds on 2.5G networks are usually in the 30-50 kbit/s range. 3G networks have taken this approach to a higher level, using different underlying technology but the same principles. They routinely provide speeds over 300 kbit/s. A further evolution is the 3.5G technology HSDPA, which has the capacity to provide speeds of multiple Megabits per second.

### D. The Wi-Fi Card

(1) History.

Wi-Fi uses both single carrier direct-sequence spread spectrum radio technology (part of the larger family of spread spectrum systems) and multi-carrier OFDM (Orthogonal Frequency Division Multiplexing) radio technology. These regulations then enabled the development of Wi-Fi, its onetime competitor HomeRF, and Bluetooth.

Unlicensed spread spectrum was first made available in the US by the Federal Communications Commission in 1985, and these FCC regulations were later copied with some changes in many other countries enabling use of this technology in all major countries.¹ The FCC action was proposed by Michael Marcus of the FCC staff in 1980 and the subsequent regulatory action took 5 more years. It was part of a broader proposal to allow civil use of spread spectrum technology, and was opposed at the time by main stream equipment manufacturers and many radio system operators. ¹Authorization of Spread Spectrum Systems Under Parts 15 and 90 of the FCC Rules and Regulations (TXT). Federal Communications Commission (Jun. 18, 1985). Retrieved on Aug. 31, 2007.

The precursor to Wi-Fi was invented in 1991 by NCR Corporation/AT&T (later Lucent & Agere Systems) in Nieuwegein, the Netherlands. It was initially intended for cashier systems. The first wireless products were brought on the market under the name WaveLAN with speeds of 1 Mbit/s to 2 Mbit/s. Vic Hayes, who held the chair of IEEE 802.11 for 10 years and has been named the father of Wi-Fi,′ was involved in designing standards, such as IEEE 802.11b, and 802.11a.

(2) Definition.

A Wi-Fi is a wireless-technology brand owned by the Wi-Fi Alliance, promotes standards with the aim of improving the interoperability of wireless local area network products based on the IEEE 802.11 standards. Common applications for Wi-Fi include Internet and VoIP phone access, gaming, and network connectivity for consumer electronics, such as televisions, DVD players, and digital cameras.

The Wi-Fi Alliance, a consortium of separate and independent companies, agrees on a set of common interoperable products based on the family of IEEE 802.11 standards.² The Wi-Fi Alliance certifies products via a set of defined test-procedures to establish interoperability. Those manufacturers with membership of Wi-Fi Alliance and whose products pass these interoperability tests can mark their products and product packaging with the Wi-Fi logo.³ ²Wi-Fi Alliance—Get to Know the Alliance. www.wi-fi.org. Retrieved on Nov. 11, 2007.³Wi-Fi Alliance—Certified Products. certifications.wi-fi.org. Retrieved on Nov. 8, 2007.

Wi-Fi technologies have gone through several generations since their inception in 1998. The Microsoft Windows, Apple Mac OS X, and open source Unix and Linux operating systems support Wi-Fi to different extents.

(3) Origin and Meaning of the Term “Wi-Fi”.

Despite the similarity between the terms “Wi-Fi” and “Hi-Fi”, statements reportedly made by Phil Belanger of the Wi-Fi Alliance contradict the conclusion that “Wi-Fi” stands for “Wireless Fidelity”.⁴ According to Belanger, the Interbrand Corporation developed the brand “Wi-Fi” for the Wi-Fi Alliance to use to describe WLAN products that are based on the IEEE 802.11 standards. In Belanger's words, Wi-Fi and the yin yang style logo were invented by Interbrand. The founding members of the Wireless Ethernet Compatibility Alliance now called as the Wi-Fi Alliance hired Interbrand to come up with the name and logo that could be used for interoperability seal and marketing efforts. ⁴ What is the True Meaning of Wi-Fi? Teleclick. Retrieved on Aug. 31, 2007; WiFi isn't short for “Wireless Fidelity”. Boing Boing. Retrieved on Aug. 31, 2007; Wireless Fidelity′ Debunked. Wi-Fi Planet. Retrieved on Aug. 31, 2007.

The Wi-Fi Alliance themselves invoked the term “Wireless Fidelity” with the marketing of a tag line “The Standard for Wireless Fidelity,” but later removed the tag from their marketing. The Wi-Fi Alliance now seems to discourage the propagation of the notion that “Wi-Fi” stands for “Wireless Fidelity”, but it has been referred to as such by the Wi-Fi Alliance in White Papers currently held in their knowledge base. “[A] promising market for wireless fidelity (Wi-Fi) network equipment.”⁵ and ”A Short History of WLANs.” The association created the Wi-Fi logo to indicate that a product had been certified for interoperability.⁶ ⁵ Enabling the Future of Wi-Fi® Public Access. Wi-Fi.org. Retrieved on Aug. 31, 2007.⁶ Securing Wi-Fi Networks with Today's Technologies.

(4) Uses.

A Wi-Fi enabled device, such as a PC, game console, cell phone, MP3 player, or PDA can connect to the Internet when within range of a wireless network connected to the Internet. The coverage of one or more interconnected access points—called a hotspot—can include an area as small as a single room with wireless-opaque walls or as large as many square miles covered by overlapping access points. Wi-Fi technology has served to set up mesh networks, for example, in London.⁷ Both architectures can operate in community networks. ⁷ Switch on for Square Mile wi-fl. news.bbc.co.uk. Retrieved on Nov. 8, 2007.

In addition to restricted use in homes and offices, Wi-Fi can make access publicly available at Wi-Fi hotspots provided either free of charge or to subscribers to various providers. Organizations and businesses, such as airports, hotels, and restaurants, often provide free hotspots to attract or assist clients. Enthusiasts or authorities who wish to provide services or even to promote business in a given area sometimes provide free Wi-Fi access. Metropolitan-wide Wi-Fi (Muni-Fi) already has more than 300 projects in process.⁸ ⁸ MuniWireless City Initiatives Directory. www.muniwireless.com. Retrieved on Mar. 12, 2008.

Wi-Fi also allows connectivity in peer-to-peer (wireless ad-hoc network) mode, which enables devices to connect directly with each other. This connectivity mode can prove useful in consumer electronics and gaming applications.

When wireless networking technology first entered the market, many problems ensued for consumers who could not rely on products from different vendors working together. The Wi-Fi Alliance began as a community to solve this issue—aiming to address the needs of the end-user and to allow the technology to mature. The Alliance created the branding Wi-Fi CERTIFIED to reassure consumers that products will interoperate with other products displaying the same branding.

Many consumer devices use Wi-Fi. Amongst others, personal computers can network to each other and connect to the Internet, mobile computers can connect to the Internet from any Wi-Fi hotspot, and digital cameras can transfer images wirelessly.

Routers incorporating a DSL-modem or a cable-modem and a Wi-Fi access point often set-up in homes and other premises provide Internet-access and internetworking to all devices connected (wirelessly or by cable) to them. One can also connect Wi-Fi devices in ad-hoc mode for client-to-client connections without a router.

As of 2007, Wi-Fi technology had spread widely within business and industrial sites. In business environments, just like other environments, increasing the number of Wi-Fi access-points provides redundancy, support for fast roaming, and increased overall network-capacity by using more channels or by defining smaller cells. Wi-Fi enables wireless voice-applications (VoWLAN or WVOIP). Over the years, Wi-Fi implementations have moved toward “thin” access-points, with more of the network intelligence housed in a centralized network appliance, relegating individual access-points to the role of mere “dumb” radios. Outdoor applications may utilize true mesh topologies. As of 2007, Wi-Fi installations can provide a secure computer networking gateway, firewall, DHCP server, intrusion detection system, and other functions.

(5) Advantages.

Wi-Fi allows LANs to be deployed without cabling for client devices, typically reducing the costs of network deployment and expansion. Spaces where cables cannot be run, such as outdoor areas and historical buildings, can host wireless LANs.

As of 2007, wireless network adapters are built into most modern laptops. The price of chipsets for Wi-Fi continues to drop making it an economical networking option included in even more devices. Wi-Fi has become widespread in corporate infrastructures.

Different competitive brands of access points and client network interfaces are inter-operable at a basic level of service. Products designated as “Wi-Fi Certified” by the Wi-Fi Alliance are backwards inter-operable. Wi-Fi is a global set of standards. Unlike mobile telephones, any standard Wi-Fi device will work anywhere in the world.

Wi-Fi is widely available in more than 250,000 public hotspots and tens of millions of homes and corporate and university campuses worldwide. WPA is not easily cracked if strong passwords are used, and WPA2 encryption has no known weaknesses. New protocols for Quality of Service (WMM) make Wi-Fi more suitable for latency-sensitive applications, such as voice and video, and power saving mechanisms (WMM Power Save) improve battery operation.

### E. The First Embodiment of the Apparatus 20

As shown in FIGS. 1 and 2, the housing 12 has a lower end 24. The apparatus 20 includes pins/sockets 26 rigidly disposed on the lower end 24 of the housing 12 and are for extending into a card slot 28 in the computer 22, thereby interfacing the Air card 14 and the Wi-Fi card 16 with the computer 22.

### F. The Second Embodiment of the Apparatus 30

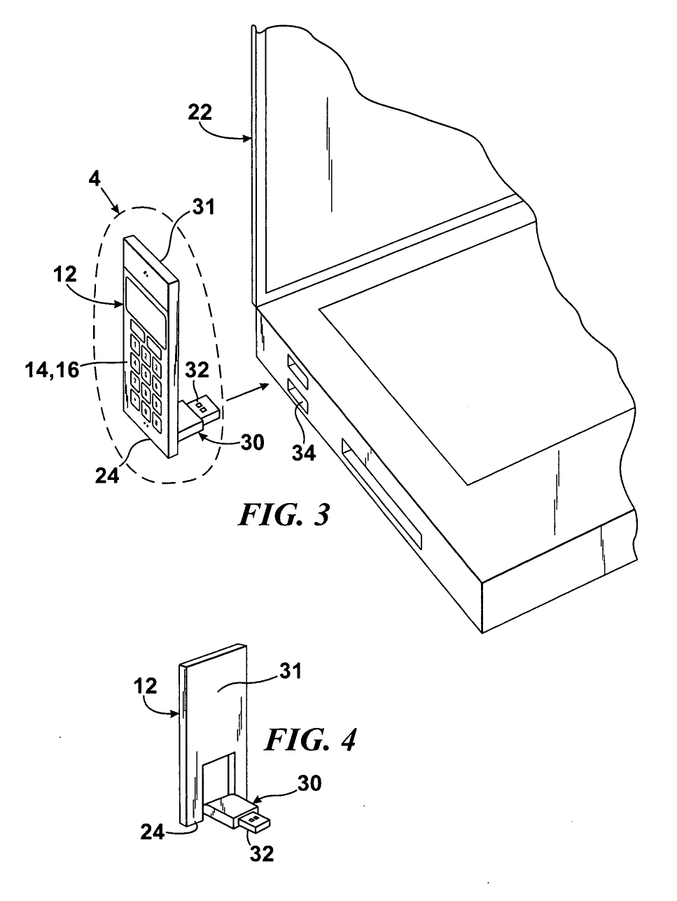

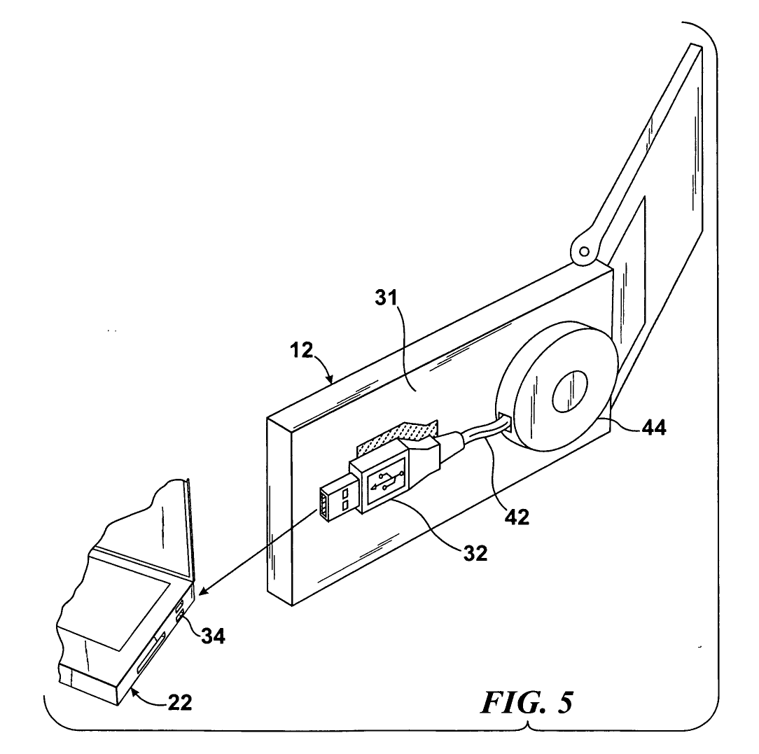

The second embodiment of the apparatus 30 can best be seen in FIGS. 3 and 4, which are, respectively, an exploded diagrammatic perspective view of a second embodiment of the combination Air card, Wi-Fi card, and cellular telephone of the present invention being inserted into a USB port of a computer, and an enlarged diagrammatic perspective view of the area generally enclosed by the dotted curve identified by ARROW 4 in FIG. 3 of the combination Air card, Wi-Fi card, and cellular telephone of the second embodiment of the present invention, and as such, will be discussed with reference thereto.

The housing 12 has a backside 31. The apparatus 30 includes a USB connector 32 pivotally hinged on the lower end 24 of the housing 12, recedes into the backside 31 of the housing 12 when not in use, and is for extending into a USB port 34 in the computer 22, thereby interfacing the Air card 14 and the Wi-Fi card 16 with the computer 22.

### G. The Third Embodiment of the Apparatus 40

The third embodiment of the apparatus 40 can best be seen in FIG. 5, which is a diagrammatic perspective view of the combination Air card, Wi-Fi card, and cellular telephone of a third embodiment of the present invention, and as such, will be discussed with reference thereto.

The apparatus 40 includes the USB connector 32 extending on a cord 42 reelingly captured in a reel 44 on the backside 31 of the housing 12 and is for selectively extending therefrom into the USB port 34 in the computer 22, thereby interfacing the Air card 14 and the Wi-Fi card 16 with the computer 22.

### H. The Conclusions

It will be understood that each of the elements described above or two or more together may also find a useful application in other types of constructions differing from the types described above.

While the embodiments of the present invention have been illustrated and described as embodied in a combination Wi-Fi card and cellular telephone, however, they are not limited to the details shown, since it will be understood that various omissions, modifications, substitutions, and changes in the forms and details of the embodiments of the present invention illustrated and their operation can be made by those skilled in the art without departing in any way from the spirit of the embodiments of the present invention.

Without further analysis the foregoing will so fully reveal the gist of the embodiments of the present invention that others can by applying current knowledge readily adapt them for various applications without omitting features that from the standpoint of prior art fairly constitute characteristics of the generic or specific aspects of the embodiments of the present invention.

The invention claimed is:

1. A combination Air card, Wi-Fi card, and cellular telephone, comprising:
a) a housing;
b) an Air card;
c) a Wi-Fi card;
d) a cellular telephone; and
e) means for interfacing said Air card and said Wi-Fi card with a computer;
wherein said Air card is contained in said housing;
wherein said Wi-Fi card is contained in said housing;
wherein said cellular telephone is contained in said housing;
wherein said cellular telephone is on said housing; and
wherein said cellular telephone operates from said housing.

2. The combination of claim 1, wherein said means is accessible from said housing.

3. The combination of claim 1, wherein said means includes pins/sockets rigidly disposed on said housing; and
wherein said pins/sockets are for extending into a card slot in the computer, thereby interfacing with the selection from the group consisting of said Air card and said Wi-Fi card and a combination of said air card and said WiFi card taken together with the computer.

4. The combination of claim 3, wherein said pins/sockets are disposed on a lower end of said housing.

5. The combination of claim 1, wherein said means includes a USB connector pivotally hinged on said housing; and
wherein said USB connector is for extending into a USB port in the computer, thereby interfacing with the selection from the group consisting of said Air card and said Wi-Fi card and a combination of said air card and said WiFi card taken together with the computer.

6. The combination of claim 5, wherein said USB connector is pivotally hinged on a lower end of said housing.

7. The combination of claim 5, wherein said USB connector recedes into a backside of said housing when not in use.

8. The combination of claim 1, wherein said apparatus includes a USB connector extending on a cord reelingly captured in a reel on a backside of said housing; and
wherein said USB connector is for selectively extending from said reel into a USB port in the computer, thereby interfacing with the selection from the group consisting of said Air card and said Wi-Fi card and a combination of said air card and said WiFi card taken together with the computer.
